(19) United States
(12) Patent Application Publication
(10) Pub. No.: US 2026/0035491 A1
(43) Pub. Date: Feb. 5, 2026

(54) SHEAR-RESISTANT, HIGH-DRAG-REDUCING, HIGH-VISCOSITY SLICKWATER DRAG REDUCING AGENT AND PREPARATION METHOD THEREFOR

(71) Applicant: SOUTHWEST PETROLEUM UNIVERSITY, CHENGDU CITY (CN)

(72) Inventors: Yongjun Guo, CHENGDU CITY (CN); Cheng Jin, CHENGDU CITY (CN); Pingya Luo, CHENGDU CITY (CN)

(21) Appl. No.: 19/358,374

(22) Filed: Oct. 14, 2025

(30) Foreign Application Priority Data
Oct. 15, 2024 (CN) 202411437862.0

(51) Int. Cl. C08F 8/12; C09K 8/68

(52) U.S. Cl. CPC C08F 8/12; C09K 8/68; C09K 2208/28

(57) ABSTRACT

The invention discloses a shear-resistant, high-drag-reducing, high-viscosity slickwater drag reducing agent and a preparation method therefor. The drag reducing agent is polymerized from acrylamide, sodium acrylate, a sulfonate ion-containing hydrophobic monomer, a hydrophobic unit microblock regulator, a molecular weight modifier, and a composite initiator. Through the special sulfonate ion-containing hydrophobic monomer, the hydrophobic unit microblock regulator matched with a hydrophobic monomer and the control of a polymer molecular weight, the solubility and viscosity-increasing performances of the polymer can be significantly improved, the shear-resistant and degradation-resistant performance of the drag reducing agent is improved, with excellent sand carrying performance and drag reducing performance, and the shortcomings of existing slickwater drag reducing agents such as weak shear resistance, rapid decline in drag reduction rate and poor sand carrying performance are overcome, thereby meeting the special requirements of deep/ultra-deep oil and gas reservoir fracturing on fracturing fluid rheology.

### FIELD OF THE INVENTION

The invention relates to the field of deep well/ultra-deep well volume fracturing, in particular, to a shear-resistant, high-drag-reducing, high-viscosity slickwater drag reducing agent and a preparation method thereof.

### BACKGROUND OF THE INVENTION

In the hydraulic fracturing process of unconventional oil and gas reservoirs, in order to increase the sand ratio of the fracturing fluid, high-viscosity slickwater (10-20 mPa·s) is increasingly used. Compared with medium- and low-viscosity slickwater, high-viscosity slickwater has better sand-carrying performance. Existing high-viscosity slickwater drag reducing agents (thickeners) are mainly high-molecular-weight polyacrylamide, with a molecular weight often greater than 25 million or even more than 30 million. The increase in the viscosity leads to a decrease in drag reduction performance, and the increase in molecular weight leads to a decrease in the shear resistance of the polymers. For fracturing of deep/ultra-deep oil and gas reservoirs, drag reducing (thickening) agents also face longer shearing time, more prominent shear degradation, and more serious loss of drag reduction performance and sand carrying performance. Therefore, improving the drag reduction, sand carrying and shear resistance of viscous slickwater drag reducing agents (thickeners) is the primary task that needs to be solved in the development of high-viscosity slickwater.

### BRIEF SUMMARY OF THE DISCLOSURE

An objective of the invention is to provide a shear-resistant, high-drag-reducing, high-viscosity slickwater drag reducing agent and a preparation method therefor for overcoming the drawbacks in the prior art. The drag reducing agent is formed by a polymerization reaction of acrylamide, sodium acrylate (or prepared by hydrolysis of acrylamide), a sulfonate ion-containing hydrophobic monomer, a hydrophobic unit microblock regulator, a molecular weight modifier, and a composite initiator. In the invention, through the special sulfonate ion-containing hydrophobic monomer, the hydrophobic unit microblock regulator matched with a hydrophobic monomer and the control of a polymer molecular weight, the solubility and viscosity-increasing performances of the polymer can be significantly improved, the shear-resistant and degradation-resistant performance of the drag reducing agent is improved, with excellent sand carrying performance and drag reducing performance, and the shortcomings of existing drag reducing agents such as weak shear resistance, rapid decline in drag reduction rate and poor sand carrying performance are overcome, thereby meeting the special requirements of deep/ultra-deep oil and gas reservoir fracturing on fracturing fluid rheology and “high drag reduction of wellbore”. The invention provides key material support for the development of deep/ultra-deep oil and gas resources, and ensures the efficient development of deep/ultra-deep oil and gas resources.

To achieve the above technical effects, the following technical solutions are used.

A shear-resistant, high-drag-reducing, high-viscosity slickwater drag reducing agent, formed by hydrolysis, i.e., a post-hydrolysis process, after a polymerization reaction of acrylamide, a sulfonate ion-containing hydrophobic monomer, a hydrophobic unit microblock regulator, a molecular weight modifier and a composite initiator, or formed by a polymerization reaction, i.e., a copolymerization process, of acrylamide, sodium acrylate, the sulfonate ion-containing hydrophobic monomer, the hydrophobic unit microblock regulator, the molecular weight modifier and the composite initiator, wherein
a molecular structure of the drag reducing agent is:

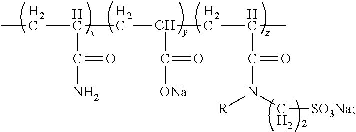

x, y, z are the numbers of each repeating unit;
a molar ratio of acrylamide to the sulfonate ion-containing hydrophobic monomer in the post-hydrolysis process is 1:0.003-0.005;
a molar ratio of acrylamide, sodium acrylate and the sulfonate ion-containing hydrophobic monomer in the copolymerization process is 1:0.2-0.4:0.003-0.005;
a mass ratio of the hydrophobic unit microblock regulator to the sulfonate ion-containing hydrophobic monomer is 4:1-2:1;
a mass ratio of a dosage of the molecular weight regulator to a reaction system is 0.0075%-0.01%;
a mass ratio of a dosage of the composite initiator to the reaction system is 0.0115%-0.0225%;
after the polymerization reaction of the post-hydrolysis process is completed, sodium hydroxide is used for post-hydrolysis, and a molar ratio of an acrylamide monomer to sodium hydroxide is 1:0.2-0.4;
a structural formula of the sulfonate ion-containing hydrophobic monomer is:

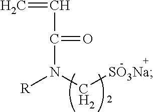

the R group is an alkyl group of C14 or an alkyl group of C16;
the hydrophobic unit microblock regulator is one or more of AEO-7, AEO-9, OP-8 and OP-10;
the molecular weight modifier is one or more of sodium formate, sodium hypophosphite, and 1-butanethiol;
the composite initiator is a multi-component initiator, which is composed of an inorganic oxidant, an organic oxidant, a reducing agent and a water-soluble azo-initiator, the inorganic oxidant being persulfate with a dosage being 0.002-0.004% of the reaction system, the organic oxidant being organic hydrogen peroxide with a dosage being 0.001-0.003% of the reaction system, the reducing agent being one of sodium sulfite and sodium bisulfite with a dosage being 0.0075-0.0125% of the reaction system, the water-soluble azo-initiator having a dosage being 0.001-0.003% of the reaction system.

Further, a molecular weight of the drag reducing agent is in a range of 20-25 million.

Further, the inorganic oxidant is ammonium persulfate, sodium persulfate, or potassium persulfate; the organic oxidant is one or more of tert-butyl hydroperoxide and cumene hydroperoxide.

Further, the water-soluble azo-initiator is one of 2,2-azo(2-(2-imidazolin-2-yl)propane) dihydrochloride, 2,2-azo(2-methyl-N-(2-hydroxyethyl)acrylamide), and 2,2-azobis(2-methylpropionamide) hydrochloride.

Further, the composite initiator is tert-butyl hydroperoxide, ammonium persulfate, sodium bisulfite, and 2,2-azo(2-(2-imidazolin-2-yl)propane) dihydrochloride.

Further, the sulfonate ion-containing hydrophobic monomer is prepared by a method of:
step S1 of adding tetradecylamine or hexadecylamine and a catalyst in sequence in a three-necked flask equipped with a magnetic stirrer, a reflux cold flow tube, a thermometer and 2 pressure equalizing addition funnels, adding sodium 2-bromoethylsulfonate or sodium 2-chloroethylsulfonate solution to one of the pressure equalizing funnels while adding a NaOH solution to the other pressure equalizing dropping funnel, controlling a pH value of a reaction by adjusting a dripping speed of the NaOH solution to perform the reaction at a temperature of 50-70° C. for 6-9h, and precipitating a precipitate in ethanol after the reaction is completed, so as to filter to obtain an intermediate of sodium 2-tetradecanoate or sodium 2-hexadecanoate;
step S2 of dissolving the intermediate prepared in the step S1 in dichloromethane while adding Na₂CO₃ as an acid binding agent, adding acryloyl chloride dropwise from the pressure equalizing addition funnel, controlling a temperature at 15-20° C. to perform a reaction for 18-24 hours and then removing dichloromethane by vacuum distillation, and then using ethanol to recrystallize to obtain a target monomer, which is the sulfonate ion-containing hydrophobic monomer.

Further, in the step S1, a molar ratio of tetradecylamine or hexadecylamine to sodium 2-bromoethylsulfonate or sodium 2-chloroethylsulfonate is 1:0.8-1:0.9, the catalyst is tetrabutylammonium bromide with a content being 1% of a mass of tetradecylamine or hexadecylamine, and an addition rate of the NaOH solution is adjusted according to pH changes to control the pH value between 9 and 12 during the reaction; in the step S2, a molar ratio of the intermediate, Na₂CO₃ and acryloyl chloride is 1:3:3.

Further, the preparation method is performed by the post-hydrolysis process or the copolymerization process:
the post-hydrolysis process in detail comprises:
   feeding the acrylamide monomer and the sulfonate ion-containing hydrophobic monomer according to a formula ratio, using ultrapure water to prepare into a mixed solution with a total monomer mass concentration of 20-35%, adding the hydrophobic unit microblock regulator and the molecular weight modifier to the mixed solution, then adjusting a pH value of the solution to 7.0-9.0, lowering a temperature of the system to 0-5° C., and then adding the water-soluble azo-initiator and the reducing agent, followed by adding an oxidant after nitrogen is introduced and stirred for 30-40 minutes and performing adiabatic polymerization for 3-8 hours and then performing granulation, hydrolysis, drying and crushing after the adiabatic polymerization is completed, so as to obtain the target polymer;
   the copolymerization process in detail comprises:
   feeding the acrylamide monomer, sodium acrylate and the sulfonate ion-containing hydrophobic monomer according to a formula ratio, using ultrapure water to prepare into a mixed solution with a total monomer mass concentration of 20-35%, adding the hydrophobic unit microblock regulator and the molecular weight modifier to the mixed solution after adjusting a pH to 7.0 using sodium hydroxide, then adjusting the pH value of the solution to 7.0-9.0, lowering a temperature of the system to 0-5° C., and then adding the water-soluble azo-initiator and the reducing agent, followed by adding an oxidant after nitrogen is introduced and stirred for 30-40 minutes and performing adiabatic polymerization for 3-8 hours and then performing granulation, drying and crushing after the adiabatic polymerization is completed, so as to obtain the target polymer.

Further, the pH value of the solution is adjusted by sodium hydroxide and acetic acid, the pH value of the solution is 8.0-8.5 after the hydrophobic unit microblock regulator is added, the temperature of the system is 0° C., and a time of the adiabatic polymerization is 5-7 hours.

The invention has the following beneficial effects:

The invention discloses a shear-resistant, high-drag-reducing, high-viscosity slickwater drag reducing agent and a preparation method therefor. The drag reducing agent is formed by a polymerization reaction of acrylamide, sodium acrylate, a sulfonate ion-containing hydrophobic monomer, a hydrophobic unit microblock regulator, a molecular weight modifier, and a composite initiator. In the invention, through the cooperation and synergistic polymerization of special sulfonate ion-containing hydrophobic monomer, the hydrophobic unit microblock regulator matched with a hydrophobic monomer and the control of a polymer molecular weight, several polymer substances work together to make the molecular structure of the synthesized polymer different from that in the prior art, so that the difference in molecular structure and the excellence of the molecular structure enable the solubility and viscosity-increasing performances of the polymer to be significantly improved, the shear-resistant and degradation-resistant performance of the drag reducing agent to be improved with excellent sand carrying performance and drag reducing performance, and the shortcomings of existing drag reducing agents such as weak shear resistance, rapid decline in drag reduction rate and poor sand carrying performance are overcome, thereby meeting the special requirements of deep/ultra-deep oil and gas reservoir fracturing on fracturing fluid rheology and “high drag reduction of wellbore”. The invention provides key material support for the development of deep/ultra-deep oil and gas resources, and ensures the efficient development of deep/ultra-deep oil and gas resources.

### BRIEF DESCRIPTION OF THE DRAWINGS

In order to explain the embodiments of the present invention or the technical solutions in the prior art more clearly, the following will briefly introduce the drawings that need to be used in the description of the embodiments or the prior art. The drawings in the following description are only embodiments of the present invention. For those of ordinary skill in the art, other drawings can be obtained based on these drawings without creative work.

FIG. 1 is an H¹-NMR spectrum of a sulfonate ion-containing hydrophobic monomer according to an embodiment of the invention;

FIG. 2 is an HPLC-MS spectrum of the sulfonate ion-containing hydrophobic monomer according to an embodiment of the invention.

### DETAILED DESCRIPTION OF THE INVENTION

In order that the objectives, technical schemes and advantages of the present invention will become more apparent, the present invention will be described in more detail with reference to the embodiments. It should be understood that the specific embodiments described herein are only for illustrating but not for limiting the present invention.

It should be noted that the following detailed descriptions are exemplary and are intended to provide further explanation of the invention. Unless defined otherwise, all technical and scientific terms used herein have the same meaning as commonly understood by those skilled in the art to which the invention belongs.

It should be noted that the terms used herein are for describing particular embodiments only and are not intended to limit the exemplary embodiments according to the invention. As used herein, unless the context clearly indicates otherwise, the singular forms are intended to include the plural forms as well. Furthermore, it should be understood that when the terms “comprises” and/or “includes” are used in this specification, they specify the presence of features, steps, operations and/or combinations thereof.

First, synthesis of a sulfonate ion-containing hydrophobic monomer is performed by a preparation method as follows.

Step S1: tetradecylamine or hexadecylamine and a catalyst (tetrabutylammonium bromide) are added in sequence in a three-necked flask equipped with a magnetic stirrer, a reflux cold flow tube, a thermometer and 2 pressure equalizing addition funnels, sodium 2-bromoethylsulfonate or sodium 2-chloroethylsulfonate solution is added to one of the pressure equalizing funnels while adding a NaOH solution to the other pressure equalizing dropping funnel, a pH value of a reaction is controlled by adjusting a dripping speed of the NaOH solution to perform the reaction at a temperature of 50-70° C. for 6-9h, and a precipitate is precipitated in ethanol after the reaction is completed, so as to filter to obtain an intermediate of sodium 2-tetradecanoate or sodium 2-hexadecanoate.

In the step S1, a molar ratio of solutions of tetradecylamine or hexadecylamine to sodium 2-bromoethylsulfonate or sodium 2-chloroethylsulfonate is 1:0.8-1:0.9, the catalyst is tetrabutylammonium bromide with a content being 1% of a mass of tetradecylamine or hexadecylamine, and the pH value is controlled between 9 and 12 by controlling a dripping speed of the sodium hydroxide solution.

Step S2: the intermediate prepared in the step S1 is dissolved in dichloromethane while adding Na₂CO₃ as an acid binding agent, acryloyl chloride is added dropwise from the pressure equalizing addition funnel, a temperature is controlled at 20° C. to perform a reaction for 18 hours and then dichloromethane is removed by vacuum distillation, and then ethanol is used to recrystallize to obtain a target monomer, which is the sulfonate ion-containing hydrophobic monomer (R group is an alkyl group of C16 or C14). In the step S2, a molar ratio of the intermediate, Na₂CO₃ and acryloyl chloride is 1:3:3.

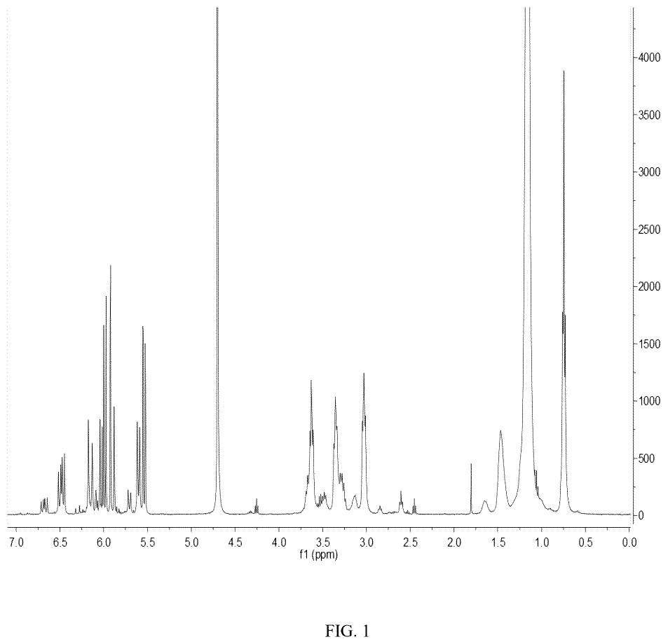

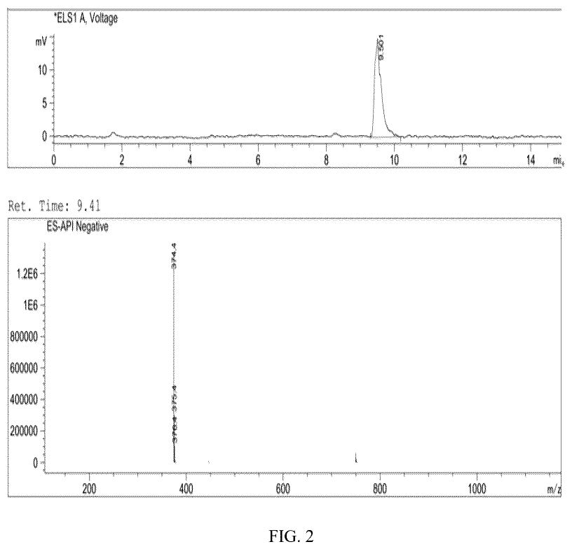

An H¹-NMR spectrum of the obtained sulfonate ion-containing hydrophobic monomer (R group is an alkyl group of C14) is shown in FIG. 1; an HPLC-MS spectrum of the sulfonate ion-containing hydrophobic monomer (R group is a C14 alkyl group) is shown in FIG. 2.

### Embodiment 1

An acrylamide monomer, a sodium acrylate monomer and the sulfonate ion-containing hydrophobic monomer (R group is an alkyl group of C16) are fed in a ratio of 1:0.3:0.004, ultrapure water is used to prepare into a mixed solution with a total monomer mass concentration of 25%; after a pH is adjusted to 7.0 using sodium hydroxide, the hydrophobic unit microblock regulator AE0-7 in an amount such that the mass ratio of the hydrophobic unit microblock regulator to the sulfonate ion-containing hydrophobic monomer is 3:1 and the molecular weight modifier sodium formate of 100 ppm are added to the mixed solution, then the pH value of the solution is adjusted to 8.0 by using sodium hydroxide and acetic acid, a temperature of the system is lowered to 0° C., and then sodium bisulfite of 100 ppm, ammonium persulfate of 30 ppm and the azo-initiator 2,2-azo(2-(2-imidazolin-2-yl)propane) dihydrochloride of 10 ppm are added, followed by adding tert-butyl hydroperoxide of 20 ppm after nitrogen is introduced and stirred for 30 minutes and performing adiabatic polymerization for 3-8 hours and then performing granulation, drying and crushing after the adiabatic polymerization is completed, so as to obtain the target polymer. A viscosity-average molecular weight of the high-temperature-resistant and salt-resistant instant fracturing fluid thickener obtained in Embodiment 1 is measured and calculated using an Ubbelohde viscometer (0.55 mm tube diameter) according to GB/T 12005.10-92, and is found to be 23 million.

### Embodiment 2

The method of Embodiment 1 is followed, except that the acrylamide monomer, the sodium acrylate monomer and the sulfonate ion-containing hydrophobic monomer are fed in a ratio of 1:0.2:0.004. A viscosity-average molecular weight of the high-temperature-resistant and salt-resistant instant fracturing fluid thickener obtained in Embodiment 2 is measured and calculated using the Ubbelohde viscometer (0.55 mm tube diameter) according to GB/T 12005.10-92, and is found to be 22.4 million.

### Embodiment 3

The method of Embodiment 1 is followed, except that the acrylamide monomer, the sodium acrylate monomer and the sulfonate ion-containing hydrophobic monomer are fed in a ratio of 1:0.4::0.004. A viscosity-average molecular weight of the high-temperature-resistant and salt-resistant instant fracturing fluid thickener obtained in Embodiment 3 is measured and calculated using the Ubbelohde viscometer (0.55 mm tube diameter) according to GB/T 12005.10-92, and is found to be 22.6 million.

### Embodiment 4

The method of Embodiment 1 is followed, except that the acrylamide monomer, the sodium acrylate monomer and the sulfonate ion-containing hydrophobic monomer are fed in a ratio of 1:0.3:0.003. A viscosity-average molecular weight of the high-temperature-resistant and salt-resistant instant fracturing fluid thickener obtained in Embodiment 4 is measured and calculated using the Ubbelohde viscometer (0.55 mm tube diameter) according to GB/T 12005.10-92, and is found to be 21.8 million.

### Embodiment 5

The method of Embodiment 1 is followed, except that the acrylamide monomer, the sodium acrylate monomer and the sulfonate ion-containing hydrophobic monomer are fed in a ratio of 1:0.3:0.005. A viscosity-average molecular weight of the high-temperature-resistant and salt-resistant instant fracturing fluid thickener obtained in Embodiment 5 is measured and calculated using the Ubbelohde viscometer (0.55 mm tube diameter) according to GB/T 12005.10-92, and is found to be 21.5 million.

### Embodiment 6

The method of Embodiment 1 is followed, except that the mass ratio of the hydrophobic unit microblock regulator to the hydrophobic monomer is 4:1. A viscosity-average molecular weight of the high-temperature-resistant and salt-resistant instant fracturing fluid thickener obtained in Embodiment 6 is measured and calculated using the Ubbelohde viscometer (0.55 mm tube diameter) according to GB/T 12005.10-92, and is found to be 22.1 million.

### Embodiment 7

The method of Embodiment 1 is followed, except that the mass ratio of the hydrophobic unit microblock regulator to the hydrophobic monomer is 2:1. A viscosity-average molecular weight of the high-temperature-resistant and salt-resistant instant fracturing fluid thickener obtained in Embodiment 7 is measured and calculated using the Ubbelohde viscometer (0.55 mm tube diameter) according to GB/T 12005.10-92, and is found to be 23.1 million.

### Embodiment 8

The method of Embodiment 1 is followed, except that the hydrophobic unit microblock regulator is changed to OP-8. A viscosity-average molecular weight of the high-temperature-resistant and salt-resistant instant fracturing fluid thickener obtained in Embodiment 8 is measured and calculated using the Ubbelohde viscometer (0.55 mm tube diameter) according to GB/T 12005.10-92, and is found to be 22.7 million.

### Embodiment 9

The method of Embodiment 1 is followed, except that the hydrophobic unit microblock regulator is changed to OP-10. A viscosity-average molecular weight of the high-temperature-resistant and salt-resistant instant fracturing fluid thickener obtained in Embodiment 9 is measured and calculated using the Ubbelohde viscometer (0.55 mm tube diameter) according to GB/T 12005.10-92, and is found to be 22.9 million.

### Embodiment 10

The method of Embodiment 1 is followed, except that the hydrophobic unit microblock regulator is changed to AEO-9. A viscosity-average molecular weight of the high-temperature-resistant and salt-resistant instant fracturing fluid thickener obtained in Embodiment 10 is measured and calculated using the Ubbelohde viscometer (0.55 mm tube diameter) according to GB/T 12005.10-92, and is found to be 22.5 million.

### Embodiment 11

The acrylamide monomer and the sulfonate ion-containing hydrophobic monomer (R group is an alkyl group of C16) are fed in a ratio of 1:0.004, ultrapure water is used to prepare into a mixed solution with a total monomer mass concentration of 25%, the hydrophobic unit microblock regulator AE0-7 in an amount such that the mass ratio of the hydrophobic unit microblock regulator to the sulfonate ion-containing hydrophobic monomer is 3:1 and the molecular weight modifier sodium formate of 100 ppm are added to the mixed solution, then a pH value of the solution is adjusted to 8.0 by using sodium hydroxide and acetic acid, a temperature of the system is lowered to 0° C., and then sodium bisulfite of 100 ppm, ammonium persulfate of 30 ppm and the azo-initiator 2,2-azo(2-(2-imidazolin-2-yl)propane) dihydrochloride of 10 ppm are added, followed by adding tert-butyl hydroperoxide of 20 ppm after nitrogen is introduced and stirred for 30 minutes and performing adiabatic polymerization for 3-8 hours and then performing granulation, hydrolysis (sodium hydroxide with a molar mass of 30% of acrylamide is added for sealing and hydrolyzing at 90° C. for 2 hours), drying and crushing after the adiabatic polymerization is completed, so as to obtain the target polymer. A viscosity-average molecular weight of the high-temperature-resistant and salt-resistant instant fracturing fluid thickener obtained in Embodiment 11 is measured and calculated using the Ubbelohde viscometer (0.55 mm tube diameter) according to GB/T 12005.10-92, and is found to be 22.6 million.

### Comparative Example 1

The method of Embodiment 1 is followed, except that the R group of the sulfonate ion-containing hydrophobic monomer is an alkyl group of C12. A viscosity-average molecular weight of the high-temperature-resistant and salt-resistant instant fracturing fluid thickener obtained in Comparative Example 1 is measured and calculated using the Ubbelohde viscometer (0.55 mm tube diameter) according to GB/T 12005.10-92, and is found to be 23.2 million.

### Comparative Example 2

The method of Embodiment 1 is followed, except that the R group of the sulfonate ion-containing hydrophobic monomer is an alkyl group of C18. A viscosity-average molecular weight of the high-temperature-resistant and salt-resistant instant fracturing fluid thickener obtained in Comparative Example 2 is measured and calculated using the Ubbelohde viscometer (0.55 mm tube diameter) according to GB/T 12005.10-92, and is found to be 22.8 million.

### Comparative Example 3

The method of Embodiment 1 is followed, except that the hydrophobic monomer is hexadecyl allyl dimethyl ammonium chloride. A viscosity-average molecular weight of the high-temperature-resistant and salt-resistant instant fracturing fluid thickener obtained in Comparative Example 3 is measured and calculated using the Ubbelohde viscometer (0.55 mm tube diameter) according to GB/T 12005.10-92, and is found to be 21.9 million.

### Comparative Example 4

The method of Embodiment 1 is followed, except that the mass ratio of the microblock regulator to the hydrophobic monomer is 5:1. A viscosity-average molecular weight of the high-temperature-resistant and salt-resistant instant fracturing fluid thickener obtained in Comparative Example 4 is measured and calculated using the Ubbelohde viscometer (0.55 mm tube diameter) according to GB/T 12005.10-92, and is found to be 22.3 million.

### Comparative Example 5

The method of Embodiment 1 is followed, except that the mass ratio of the microblock regulator to the hydrophobic monomer is 1:2. A viscosity-average molecular weight of the high-temperature-resistant and salt-resistant instant fracturing fluid thickener obtained in Comparative Example 5 is measured and calculated using the Ubbelohde viscometer (0.55 mm tube diameter) according to GB/T 12005.10-92, and is found to be 22.5 million.

### Comparative Example 6

The method of Embodiment 1 is followed, except that the dosage of the molecular weight modifier sodium formate is increased to 175 ppm. A viscosity-average molecular weight of the high-temperature-resistant and salt-resistant instant fracturing fluid thickener obtained in Comparative Example 6 is measured and calculated using the Ubbelohde viscometer (0.55 mm tube diameter) according to GB/T 12005.10-92, and is found to be 18 million.

### Comparative Example 7

The method of Embodiment 1 is followed, except that the dosage of the molecular weight modifier sodium formate is decreased to 50 ppm. A viscosity-average molecular weight of the high-temperature-resistant and salt-resistant instant fracturing fluid thickener obtained in Comparative Example 7 is measured and calculated using the Ubbelohde viscometer (0.55 mm tube diameter) according to GB/T 12005.10-92, and is found to be 27 million.

### Comparative Example 8

The method of Embodiment 1 is followed, except that the microblock regulator is changed to AEO-5. A viscosity-average molecular weight of the high-temperature-resistant and salt-resistant instant fracturing fluid thickener obtained in Comparative Example 8 is measured and calculated using the Ubbelohde viscometer (0.55 mm tube diameter) according to GB/T 12005.10-92, and is found to be 22.5 million.

### Comparative Example 9

The method of Embodiment 1 is followed, except that the microblock regulator is changed to OP-7. A viscosity-average molecular weight of the high-temperature-resistant and salt-resistant instant fracturing fluid thickener obtained in Comparative Example 9 is measured and calculated using the Ubbelohde viscometer (0.55 mm tube diameter) according to GB/T 12005.10-92, and is found to be 22.1 million.

### Comparative Example 10

The method of Embodiment 1 is followed, except that the microblock regulator is changed to OP-13. A viscosity-average molecular weight of the high-temperature-resistant and salt-resistant instant fracturing fluid thickener obtained in Comparative Example 10 is measured and calculated using the Ubbelohde viscometer (0.55 mm tube diameter) according to GB/T 12005.10-92, and is found to be 22.3 million.

### Comparative Example 11

The method of Embodiment 1 is followed, except that no hydrophobic unit microblock regulator is added. A viscosity-average molecular weight of the high-temperature-resistant and salt-resistant instant fracturing fluid thickener obtained in Comparative Example 11 is measured and calculated using the Ubbelohde viscometer (0.55 mm tube diameter) according to GB/T 12005.10-92, and is found to be 22.2 million.

### Comparative Example 12

The method of Embodiment 1 is followed, except that no azo component is added to the initiator. The reaction fails, the colloid is very soft, and there is a large amount of unpolymerized liquid.

### Comparative Example 13

The method of Embodiment 1 is followed, except that no ammonium persulfate is added to the initiator. The reaction fails. After the temperature of the reaction is raised to 20° C., the temperature is no longer raised, and a large amount of monomers does not polymerize, resulting in failed reaction.

### Comparative Example 14

The method of Embodiment 1 is followed, except that no tert-butyl hydroperoxide is added to the initiator. The reaction cannot be initiated and the polymerization fails.

### Comparative Example 15

The mainstream high-molecular-weight drag reducing agent on the market is partially hydrolyzed polyacrylamide, with a molecular weight of 30 million and a degree of hydrolysis of 30%.

An evaluation method for the performance of polymer solutions is as follows.

### (1) Test for Viscous-Becoming Time

Water of 400 mL is added to 1000 mL beakers respectively, the sample with a mass fraction of 0.05% (500 ppm) is added at a stirring speed of 500 r/min, and then a viscous-becoming time (a glass rod can be used for wire drawing) after a thickener is added is recorded. The specific data are shown in Table 1.

### (2) Test for Viscosity-Increasing Performance

The samples are stirred in clean water at 25° C. and 500 r/min for 3 min, and the viscosities of the samples at concentrations from 500 ppm to 1200 ppm are measured using a 6 speed viscometer at 170 s⁻¹. The concentrations corresponding to viscosities of 10 mPa·s and 20 mPa·s for each sample are then found through fitting and concentration adjustment, and the results are shown in Table 1.

TABLE 1
Viscous-becoming time and concentrations corresponding
to10 mPa · s and 20 mPa · s for samples

| | |
|---|---|
| Viscous- | |
| becoming | |
| time/s at | Concentration (ppm) |

| Groups | 500 ppm | 10 mPa · s | 20 mPa · s |
|---|---|---|---|
| Embodiment 1 | 21 | 520 | 720 |
| Embodiment 2 | 21 | 530 | 735 |
| Embodiment 3 | 12 | 510 | 705 |
| Embodiment 4 | 20 | 550 | 760 |
| Embodiment 5 | 22 | 500 | 690 |
| Embodiment 6 | 20 | 550 | 770 |
| Embodiment 7 | 24 | 480 | 690 |
| Embodiment 8 | 24 | 520 | 700 |
| Embodiment 9 | 23 | 525 | 720 |
| Embodiment 10 | 24 | 525 | 710 |
| Embodiment 11 | 21 | 520 | 720 |
| Comparative Example 1 | 18 | 690 | 1060 |
| Comparative Example 2 | 75 | / | / |
| Comparative Example 3 | 19 | 665 | 1050 |
| Comparative Example 4 | 19 | 670 | 985 |
| Comparative Example 5 | 62 | / | / |
| Comparative Example 6 | 16 | 650 | 945 |
| Comparative Example 7 | 52 | / | / |
| Comparative Example 8 | 68 | / | / |
| Comparative Example 9 | 51 | / | / |
| Comparative Example 10 | 53 | / | / |
| Comparative Example 11 | 65 | / | / |
| Comparative Example 12 | / | / | / |
| Comparative Example 13 | / | / | / |
| Comparative Example 14 | / | / | / |
| Comparative Example 15 | 15 | 680 | 1150 |

“/” indicates that dissolution cannot be completed.

The polymers in the comparative examples that failed to meet the standards in the tests for viscosity-increasing performance and viscous-becoming time are not evaluated for other performances.

### (3) Drag Reduction Rate

Drag reduction rates of the embodiments are tested by measuring in accordance with the provisions of Chapter 7.8 of SY-T 7627-2021 for determining the drag reduction rate. The drag reduction rate data for 5 minutes is taken as the drag reduction rate value, as shown in Table 2.

TABLE 2
Drag reduction rate corresponding to sample viscosities
of 10 mPa · s and 20 mPa · s

| Groups | 10 mPa · s/% | 20 mPa · s/% |
|---|---|---|
| Embodiment 1 | 76.03 | 73.81 |
| Embodiment 2 | 75.93 | 73.72 |
| Embodiment 3 | 75.63 | 72.81 |
| Embodiment 4 | 75.81 | 73.44 |
| Embodiment 5 | 76.21 | 73.83 |
| Embodiment 6 | 75.93 | 73.64 |
| Embodiment 7 | 76.41 | 73.87 |
| Embodiment 8 | 76.02 | 73.64 |
| Embodiment 9 | 76.03 | 73.81 |
| Embodiment 10 | 75.50 | 73.89 |
| Embodiment 11 | 76.21 | 73.61 |
| Comparative Example 1 | 73.13 | 69.67 |
| Comparative Example 3 | 74.33 | 68.68 |
| Comparative Example 4 | 74.43 | 70.56 |
| Comparative Example 6 | 74.23 | 70.87 |
| Comparative Example 15 | 74.34 | 67.81 |

### (4) Test for Sand Carrying Performance

A volume of 1000 mL is taken to prepare about a target solution of 400 mL, and stirred at 500 r/min for 3 minutes during sample preparation. A test solution of 100 mL is poured into a graduated cylinder of 100 mL, and then a sedimentation speed of 20/40 mesh ceramsite in the graduated cylinder is tested. The sedimentation speeds of 20 ceramsite particles are tested repeatedly, and then the average values are taken, as shown in Table 3.

TABLE 3
Sedimentation speeds corresponding to sample viscosities
of 10 mPa · s and 20 mPa · s

| Groups | 10 mPa · s (cm/s) | 20 mPa · s (cm/s) |
|---|---|---|
| Embodiment 1 | 8.76 | 4.81 |
| Embodiment 2 | 8.88 | 4.92 |
| Embodiment 3 | 8.32 | 4.56 |
| Embodiment 4 | 8.92 | 5.01 |
| Embodiment 5 | 8.78 | 4.57 |
| Embodiment 6 | 8.56 | 4.96 |
| Embodiment 7 | 8.81 | 4.47 |
| Embodiment 8 | 8.74 | 4.76 |
| Embodiment 9 | 8.67 | 4.75 |
| Embodiment 10 | 8.56 | 4.92 |
| Embodiment 11 | 8.77 | 4.82 |
| Comparative Example 1 | 9.76 | 5.49 |
| Comparative Example 3 | 9.98 | 5.42 |
| Comparative Example 4 | 9.78 | 5.61 |
| Comparative Example 6 | 10.78 | 5.77 |
| Comparative Example 15 | 10.71 | 5.79 |

### (5) Test for Shear Resistant Performance

A beaker with a volume of 1000 mL is taken to prepare about a target solution of 400 mL, and stirred at 500 r/min for 3 minutes during sample preparation. A test liquid of 300 mL is taken, measured for a viscosity value (mPa·s) at 170 s⁻¹ using the 6 speed rotational viscometer, and is poured into a WARING blender and sheared at a speed of 3000 r/min for 5 min after the test; then, the viscosity after the shear is measured, and finally viscosity retention values before and after shear are calculated, as shown in Table 4.

TABLE 4
Viscosity retention rate before and after shear corresponding
to sample viscosities of 10 mPa · s and 20 mPa s

| Groups | 10 mPa · s | 20 mPa · s |
|---|---|---|
| Embodiment 1 | 94% | 97% |
| Embodiment 2 | 96% | 97% |
| Embodiment 3 | 92% | 95% |
| Embodiment 4 | 92% | 94% |
| Embodiment 5 | 95% | 98% |
| Embodiment 6 | 92% | 94% |
| Embodiment 7 | 96% | 98% |
| Embodiment 8 | 95% | 97% |
| Embodiment 9 | 93% | 96% |
| Embodiment 10 | 94% | 96% |
| Embodiment 11 | 95% | 97% |
| Comparative Example 1 | 54% | 76% |
| Comparative Example 3 | 76% | 86% |
| Comparative Example 4 | 84% | 90% |
| Comparative Example 6 | 81% | 86% |
| Comparative Example 15 | 41% | 60% |

In summary, the invention discloses a shear-resistant, high-drag-reducing, high-viscosity slickwater drag reducing agent and a preparation method therefor. The drag reducing agent is formed by a polymerization reaction of acrylamide, sodium acrylate, a sulfonate ion-containing hydrophobic monomer, a hydrophobic unit microblock regulator, a molecular weight modifier, and a composite initiator. In the invention, through the cooperation and synergistic polymerization of special sulfonate ion-containing hydrophobic monomer, the hydrophobic unit microblock regulator matched with a hydrophobic monomer and the control of a polymer molecular weight, several polymer substances work together to make the molecular structure of the synthesized polymer different from that in the prior art, so that the difference in molecular structure and the excellence of the molecular structure enable the solubility and viscosity-increasing performances of the polymer to be significantly improved, the shear-resistant and degradation-resistant performance of the drag reducing agent to be improved with excellent sand carrying performance and drag reducing performance, and the shortcomings of existing drag reducing agents such as weak shear resistance, rapid decline in drag reduction rate and poor sand carrying performance are overcome, thereby meeting the special requirements of deep/ultra-deep oil and gas reservoir fracturing on fracturing fluid rheology and “high drag reduction of wellbore”. The invention provides key material support for the development of deep/ultra-deep oil and gas resources, and ensures the efficient development of deep/ultra-deep oil and gas resources.

Those skilled in the art realize that although the embodiments of the invention have been shown and described in detail herein, many other variations or modifications consistent with the principles of the invention can be directly determined or derived based on the contents disclosed herein without departing from the spirit and scope of the invention. Therefore, the scope of the invention should be understood and deemed to encompass all such other variations and modifications.

1. A shear-resistant, high-drag-reducing, high-viscosity slickwater drag reducing agent, formed by hydrolysis, i.e., a post-hydrolysis process, after a polymerization reaction of acrylamide, a sulfonate ion-containing hydrophobic monomer, a hydrophobic unit microblock regulator, a molecular weight modifier and a composite initiator, or formed by a polymerization reaction, i.e., a copolymerization process, of acrylamide, sodium acrylate, the sulfonate ion-containing hydrophobic monomer, the hydrophobic unit microblock regulator, the molecular weight modifier and the composite initiator, wherein
a molecular structure of the drag reducing agent is: 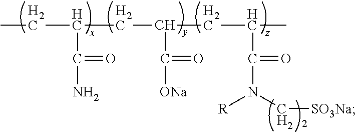
x, y, z are the numbers of each repeating unit;
a molar ratio of acrylamide to the sulfonate ion-containing hydrophobic monomer in the post-hydrolysis process is 1:0.003-0.005;
a molar ratio of acrylamide, sodium acrylate and the sulfonate ion-containing hydrophobic monomer in the copolymerization process is 1:0.2-0.4:0.003-0.005;
a mass ratio of the hydrophobic unit microblock regulator to the sulfonate ion-containing hydrophobic monomer is 4:1-2:1;
a mass ratio of a dosage of the molecular weight regulator to a reaction system is 0.0075%-0.01%;
a mass ratio of a dosage of the composite initiator to the reaction system is 0.0115%-0.0225%;
after the polymerization reaction of the post-hydrolysis process is completed, sodium hydroxide is used for post-hydrolysis, and a molar ratio of an acrylamide monomer to sodium hydroxide is 1:0.2-0.4;
a structural formula of the sulfonate ion-containing hydrophobic monomer is: 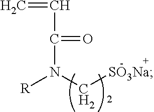
the R group is an alkyl group of C14 or an alkyl group of C16;
the hydrophobic unit microblock regulator is one or more of AEO-7, AEO-9, OP-8 and OP-10;
the molecular weight modifier is one or more of sodium formate, sodium hypophosphite, and 1-butanethiol;
the composite initiator is a multi-component initiator, which is composed of an inorganic oxidant, an organic oxidant, a reducing agent and a water-soluble azo-initiator, the inorganic oxidant being persulfate with a dosage being 0.002-0.004% of the reaction system, the organic oxidant being organic hydrogen peroxide with a dosage being 0.001-0.003% of the reaction system, the reducing agent being one of sodium sulfite and sodium bisulfite with a dosage being 0.0075-0.0125% of the reaction system, the water-soluble azo-initiator having a dosage being 0.001-0.003% of the reaction system.

2. The shear-resistant, high-drag-reducing, high-viscosity slickwater drag reducing agent according to claim 1, wherein a molecular weight of the drag reducing agent is in a range of 20-25 million.

3. The shear-resistant, high-drag-reducing, high-viscosity slickwater drag reducing agent according to claim 1, wherein the inorganic oxidant is ammonium persulfate, sodium persulfate, or potassium persulfate; the organic oxidant is one or more of tert-butyl hydroperoxide and cumene hydroperoxide.

4. The shear-resistant, high-drag-reducing, high-viscosity slickwater drag reducing agent according to claim 1, wherein the water-soluble azo-initiator is one of 2,2-azo(2-(2-imidazolin-2-yl)propane) dihydrochloride, 2,2-azo(2-methyl-N-(2-hydroxyethyl)acrylamide), and 2,2-azobis(2-methylpropionamide) hydrochloride.

5. The shear-resistant, high-drag-reducing, high-viscosity slickwater drag reducing agent according to claim 1, wherein the composite initiator is tert-butyl hydroperoxide, ammonium persulfate, sodium bisulfite, and 2,2-azo(2-(2-imidazolin-2-yl)propane) dihydrochloride.

6. The shear-resistant, high-drag-reducing, high-viscosity slickwater drag reducing agent according to claim 1, wherein the sulfonate ion-containing hydrophobic monomer is prepared by a method of:
step S1 of adding tetradecylamine or hexadecylamine and a catalyst in sequence in a three-necked flask equipped with a magnetic stirrer, a reflux cold flow tube, a thermometer and 2 pressure equalizing addition funnels, adding sodium 2-bromoethylsulfonate or sodium 2-chloroethylsulfonate solution to one of the pressure equalizing funnels while adding a NaOH solution to the other pressure equalizing dropping funnel, controlling a pH value of a reaction by adjusting a dripping speed of the NaOH solution to perform the reaction at a temperature of 50-70° C. for 6-9 h, and precipitating a precipitate in ethanol after the reaction is completed, so as to filter to obtain an intermediate of sodium 2-tetradecanoate or sodium 2-hexadecanoate;
step S2 of dissolving the intermediate prepared in the step S1 in dichloromethane while adding Na₂CO₃ as an acid binding agent, adding acryloyl chloride dropwise from the pressure equalizing addition funnel, controlling a temperature at 15-20° C. to perform a reaction for 18-24 hours and then removing dichloromethane by vacuum distillation, and then using ethanol to recrystallize to obtain a target monomer, which is the sulfonate ion-containing hydrophobic monomer.

7. The shear-resistant, high-drag-reducing, high-viscosity slickwater drag reducing agent according to claim 6, wherein in the step S1, a molar ratio of tetradecylamine or hexadecylamine to sodium 2-bromoethylsulfonate or sodium 2-chloroethylsulfonate is 1:0.8-1:0.9, the catalyst is tetrabutylammonium bromide with a content being 1% of a mass of tetradecylamine or hexadecylamine, and an addition rate of the NaOH solution is adjusted according to pH changes to control the pH value between 9 and 12 during the reaction; in the step S2, a molar ratio of the intermediate, Na₂CO₃ and acryloyl chloride is 1:3:3.

8. The preparation method for a shear-resistant, high-drag-reducing, high-viscosity slickwater drag reducing agent according to claim 7, wherein the preparation method is performed by the post-hydrolysis process or the copolymerization process:
the post-hydrolysis process in detail comprises:
feeding the acrylamide monomer and the sulfonate ion-containing hydrophobic monomer according to a formula ratio, using ultrapure water to prepare into a mixed solution with a total monomer mass concentration of 20-35%, adding the hydrophobic unit microblock regulator and the molecular weight modifier to the mixed solution, then adjusting a pH value of the solution to 7.0-9.0, lowering a temperature of the system to 0-5° C., and then adding the water-soluble azo-initiator and the reducing agent, followed by adding an oxidant after nitrogen is introduced and stirred for 30-40 minutes and performing adiabatic polymerization for 3-8 hours and then performing granulation, hydrolysis, drying and crushing after the adiabatic polymerization is completed, so as to obtain the target polymer;
the copolymerization process in detail comprises:
feeding the acrylamide monomer, sodium acrylate and the sulfonate ion-containing hydrophobic monomer according to a formula ratio, using ultrapure water to prepare into a mixed solution with a total monomer mass concentration of 20-35%, adding the hydrophobic unit microblock regulator and the molecular weight modifier to the mixed solution after adjusting a pH to 7.0 using sodium hydroxide, then adjusting the pH value of the solution to 7.0-9.0, lowering a temperature of the system to 0-5° C., and then adding the water-soluble azo-initiator and the reducing agent, followed by adding an oxidant after nitrogen is introduced and stirred for 30-40 minutes and performing adiabatic polymerization for 3-8 hours and then performing granulation, drying and crushing after the adiabatic polymerization is completed, so as to obtain the target polymer.

9. The preparation method according to claim 8, wherein the pH value of the solution is adjusted by sodium hydroxide and acetic acid, the pH value of the solution is 8.0-8.5 after the hydrophobic unit microblock regulator is added, the temperature of the system is 0° C., and a time of the adiabatic polymerization is 5-7 hours.
